(19) United States
(12) Patent Application Publication
(10) Pub. No.: US 2003/0063955 A1
(43) Pub. Date: Apr. 3, 2003

(54) Superabrasive cutting tool

(76) Inventors: Jerome Cheynet De Beaupre, Sandy, UT (US); Daniel J. Miess, Orem, UT (US); Monte E. Russell, Orem, UT (US)

Correspondence Address: CHRISTIE, PARKER & HALE, LLP, 350 WEST COLORADO BOULEVARD, SUITE 500, PASADENA, CA, 91105, US

(21) Appl. No.: 09/966,396

(22) Filed: Sep. 28, 2001

(51) Int. Cl. B26D 1/00; B26D 3/00; B23P 15/28; B24B 5/00; B24B 7/00; B24B 7/16; B23F 21/03; B23F 21/23; B24B 33/00; C09C 1/68; B24D 3/02; C09K 3/14

(52) U.S. Cl. 407/119; 451/540; 51/309

(57) ABSTRACT

A superabrasive cutting insert formed from a generally flat composite wafer of predetermined shape and thickness. The wafer includes a center layer of ultra-hard material, which is integrally bonded to top and bottom support layers or in some cases a single support layer. The outer edge of the center layer forms at least one cutting edge along at least one side of the wafer. The wafer includes at least one profiled chip breaker formed inwardly of the cutting edge by selectively removing a portion of at least one of the support layers inwardly from the cutting edge.

### BACKGROUND OF THE INVENTION

The present invention relates to the field of superabrasive flat cutting inserts and more particularly to a super abrasive flat cutting insert with chip breaker features. Such inserts are commonly used in metal removal operations such as turning, milling, and boring.

Superabrasive flat cutting inserts, commonly referred to as “compacts,” are typically composed of a sandwich composite formed with a central cutting layer composed of polycrystalline diamond (“PCD”), polycrystalline cubic boron nitride (“PCBN”), and similar ultra-hard materials. Supporting the cutting layer on at least one and typically both flat sides is a layer of softer metal or cemented carbide, such as tungsten carbide, which is integrally bonded to the ultra-hard cutting layer during the high-pressure, high-temperature process in which the ultra-hard material is sintered.

In turning operations on metals or other materials, a cutting insert is typically clamped to a tool holder, which in turn is mounted on a lathe or similar machine tool. The machine tool causes the cutting insert to engage a rotating workpiece. As the cutting insert engages the workpiece, a ribbon-like strip of metal or other material is removed from the workpiece. The strip or ribbon is cut off from the workpiece at the edge of the cutting insert. Such ribbons of metal may also result from drilling operations. Control of this ribbon of metal is important for a number of reasons. If the strip taken off from the workpiece by the cutting insert is not broken, the strip can feed into the tool holder and other portions of the machine and may cause problems such as damaging parts of the tool holder or obstructing visibility of the working area. Long ribbons are particularly difficult to handle and can represent a hazard to the machine operator in metal turning operations.

Preferably, the cutting insert includes a chip breaker in the form of a land or other protrusion, which causes the metal ribbon taken off the workpiece to break up into short pieces or chips upon striking the land. The chips subsequently fall away from the machining region into a receiving space or container. Like turning operations, in boring operations ribbon break-up is also important in order to increase boring efficiency and to prevent damage to the cutting insert.

With conventional cutting inserts formed from hardened tool steel a chip breaker land may be machined directly into the insert. Typically, the chip breaker land is highly polished to prevent build up at the base of the land of a ridge or edge of metal debris, which would reduce the chip breaker's effectiveness.

In cutting inserts formed from cemented tungsten carbide blanks, chip breaker geometries are typically formed in the carbide blank during the blank molding operation. After molding, the chip breaker lands may be polished or ground to form a smooth surface. Following the example of tungsten carbide cutting inserts with molded-in chip breakers; attempts have also been made to mold chip breakers directly in blanks of polycrystalline diamond and other ultra-hard materials. These attempts have met with some success. However, due to the difficulties involved in polishing polycrystalline diamond, current molded-in chip breakers are left in the “as molded” or “as pressed” condition, which is relatively rough in comparison to a ground metal surface. A rough chip breaker surface is undesirable in that a rough surface tends to cause a ridge of metal fragments to build up at the base of the chip breaker land. The built up metal ridge subsequently tends to impede the formation of chips and thus significantly degrades the performance of the chip breaker.

Another method used for providing a chip breaker for PCD or PCBN inserts is to clamp a separate plate made of cemented carbide or similar material on top of the insert's ultra-hard cutting tip. The drawback of this method is that since the chip breaker is separate from the ultra-hard cutting layer, and it is possible to have a gap between the chip breaker plate and the ultra-hard layer. During machining operations, =workpiece material may build up in this gap. In addition, the two surfaces of the chip breaker plate and the ultra-hard layer may not be perfectly mated, resulting in high stresses and possible fracture of the ultra-hard layer when the two are clamped together in the tool holder.

What is needed therefore is an effective design for a superabrasive cutting insert that includes a chip breaker that is directly bonded to the ultra-hard layer. The cutting insert should utilize PCD or PCBN or similar ultra-hard materials as the cutting element and should include a smooth chip breaker land to avoid the metal edge build-up that has plagued the molded-in chip breakers of previous cutting inserts formed from ultra-hard materials.

### SUMMARY OF THE INVENTION

The present invention is directed towards a superabrasive cutting insert or compact where a chip breaker is formed into at least one of the layers supporting the ultra-hard material cutting surface. Preferably, the cutting insert is a sintered composite having a base layer of tungsten or cemented tungsten carbide, a central cutting layer of PCD or PCBN, and a top layer of cemented tungsten carbide. Preferably, the chip breaker is formed by machining the tungsten carbide top layer to form a profiled chip breaker land and to expose a portion of the polycrystalline diamond or CBN layer to form the cutting edge. The chip breaker profile may be angled or ramped, concave or convex, or of other suitable design, and should be comparatively smooth so as to provide for the formation of chips without creating edge build-up. The chip breaker is preferably formed by either grinding or EDM machining. Other suitable methods of forming the chip breaker include laser machining and ultrasonic abrading.

The primary advantages of the present invention are the ability to form chip breaker lands on cutting inserts that heretofore have not benefitted from chip breaker technology, and the chip control that should be realized by use of the chip breaker equipped cutting inserts of the present invention. Other features and advantages of the invention will become more apparent from the following detailed description of the invention, when taken in conjunction with the accompanying exemplary drawings.

### BRIEF DESCRIPTION OF THE DRAWINGS

FIG. 1 is a perspective view of a typical tool holder used in metal turning operations with a cutting insert of the present invention mounted thereon.

FIG. 2 is a perspective view of the cutting insert of the present invention.

FIG. 3A is a sectional view, enlarged in scale, taken along the line a-a, showing one embodiment of the formed chip breaker of the present invention.

FIG. 3B is a sectional view, enlarged in scale, taken along the line a-a, showing another embodiment of the formed chip breaker of the present invention.

FIG. 3C is a sectional view, enlarged in scale, taken along the line a-a, showing a third embodiment of the formed chip breaker of the present invention.

### DETAILED DESCRIPTION OF THE INVENTION

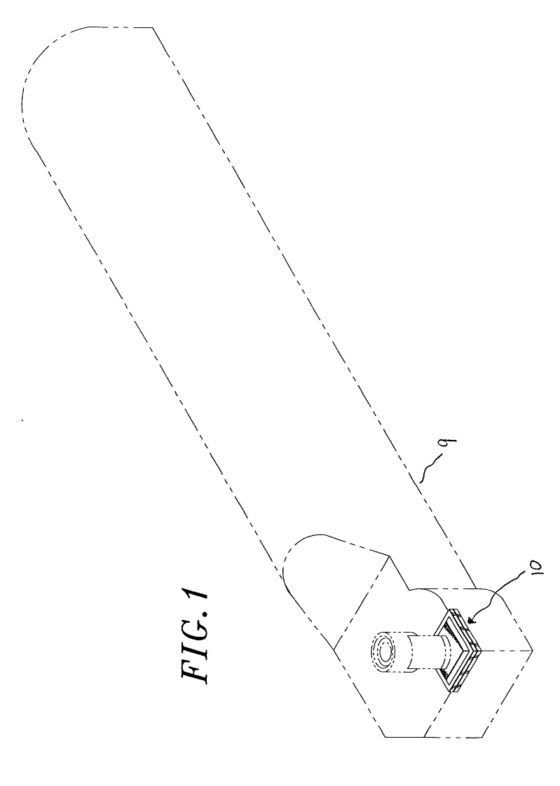

Referring to FIG. 1, an exemplary embodiment of a cutting insert 10 is shown clamped in a typical tool holder 9 of the type commonly used in metal turning operations. The tool holder 9 is shown for illustrative purposes only. Many variations of tool holders are known in the art. The tool holder is mounted in a machine tool, such as a lathe, and serves to support the cutting insert 10 and in conjunction with the machine tool to engage the cutting insert with a workpiece.

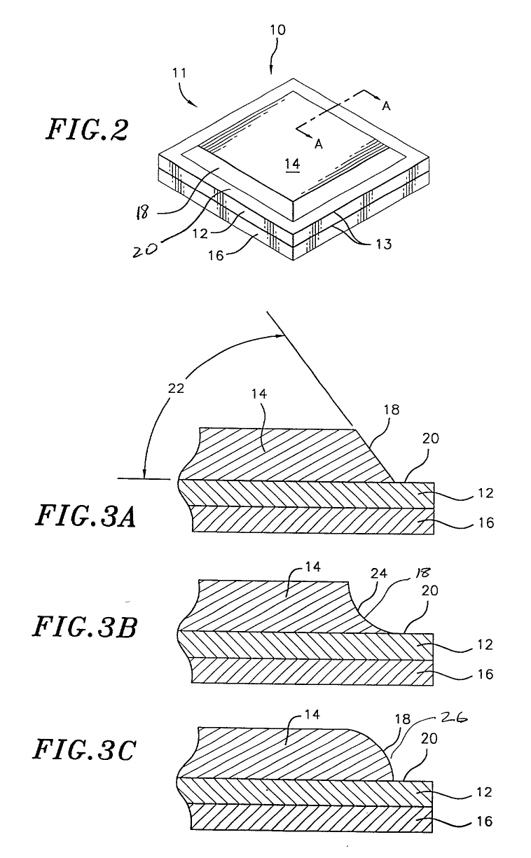

Referring to FIG. 2, an exemplary embodiment of a flat composite cutting insert 10 of the present invention is shown in more detail. The cutting insert is formed as a composite wafer 11 which includes a central cutting layer 12 which is composed of an ultra-hard material. Preferably, the cutting layer is composed of either PCD or PCBN. However, other similar polycrystalline materials are also suitable. Integrally joined to the cutting layer are a top support layer 14 and a bottom support layer 16. Generally, these support layers are made from metallic materials that are comparatively softer than the ultra-hard cutting layer. In the preferred embodiment, the top support layer is made of cemented tungsten carbide and the lower support layer is made of cemented tungsten carbide, tungsten or an alloy of tungsten. However, the support layers are not limited to these materials and many alternative materials such as tantalum, niobium, palladium, iron, nickel, cobalt, alloys of such metals, and intermetallic compounds containing such metals, are also suitable.

In an alternative embodiment (not shown), the composite wafer 11 may be composed of only two layers. One layer is the cutting layer 12 which is composed of an ultra-hard material and the other layer is a support layer composed of a comparatively softer metallic material. In certain insert designs, this type of construction may be preferred.

The cutting insert 10 also includes a plurality of cutting edges 13 which comprise the exposed outside edges of the cutting layer 12. Formed inwardly from the cutting edge is a chip breaker 18. The term “chip breaker” as used here is meant to refer to a land, groove, or other profiled surface which serves to break a metal ribbon severed from a workpiece by a cutting edge into chips. To form the chip breaker, a portion of one of the support layers is removed inwardly from the cutting edge to expose a free surface 20 of ultra-hard material and to form a profiled surface which comprises the chip breaker 18. The chip breaker may be formed in either the top support layer 14 or the bottom support layer 16. For convenience, the chip breaker is shown formed into the upper support layer in FIG. 2. It is highly advantageous to form the chip breaker in one of the comparatively soft support layers. Unlike the difficult to machine ultra-hard cutting layer in which prior art chip breakers have been molded, the comparatively soft support layers are easily machined in post molding operations and a variety of comparatively smooth chip breaker profiles may be formed. In some applications, it may be desirable to form a chip breaker in both the top and bottom support layers. It should be noted that the terms “upper,” “lower,” “top,” and “bottom” are used herein for convenience to describe the relative and not the exact position or orientation of elements and parts.

The manufacture and composition of polycrystalline composite wafers or blanks are well known. In general, the composite wafer 11 is formed by sandwiching the central polycrystalline layer of ultra-hard material between the top layer 14, typically tungsten carbide, and the bottom layer 16, typically tungsten or tungsten carbide. The composite is then placed in a press where it is sintered at high pressure and temperature. As a result of the sintering process, some material from the upper and lower support layers diffuse into the polycrystalline layer thereby producing the integral composite wafer 11. The wafer may then be cut to the desired geometry and the cutting edges and support layers may be machined as desired.

More details on the composition of polycrystalline diamond wafers may be found in U.S. Pat. Nos. 3,745,623 and 3,609,818. Details on the chemical composition of polycrystalline CBN wafers may be found in U.S. Pat. Nos. 3,767,371 and 3,743,489. More details on the high temperature, high pressure processing of polycrystalline composite wafers may be found in U.S. Pat. Nos. 2,947,617, 4,188,194, and 4,289,503. Other references may be found in the art.

Generally, for reliable chip formation, Applicants have discovered that the chip breaker 18 should have a height (equivalent to the thickness of the support layer) of about 0.010 to about 0.125 inches. The actual height of the chip breaker will depend on the overall size of the cutting insert and the intended application. Furthermore Applicants have discovered that reliable chip formation occurs when the depth of the cutting layer free surface 20 is within the range of about 0.010 to about 0.125 inches. The chip breaker may be formed by diamond grinding, EDM machining, and laser machining. Other suitable methods of forming the chip breaker are known in the art.

Referring now to FIGS. 3A-3C, the chip breaker 18 may have a variety of profiles, including but not limited to those depicted. FIG. 3A shows a ramp type profile. Experimentation has shown that reliable chip formation occurs when the ramp angle 22 is within a range of about 5 to about 60 degrees. FIG. 3B shows concave chip breaker profile. With this form of chip breaker, experimentation has shown that reliable chip formation occurs with a radius of curvature 24 within a range of about 0.010 to about 0.100 inches. FIG. 3C shows convex chip breaker profile. With this form of chip breaker, experimentation has shown that reliable chip formation occurs with a radius of curvature 26 within a range of about 0.010 to about 0.100 inches. Other chip breaker profiles are known in the art and are also suitable. The geometry and dimensions of the chip breaker profile vary greatly depending on the cutting tool grade, the workpiece material and the machining application.

Referring again to FIG. 2, the cutting insert 10 is of predetermined shape and of selected thickness. While the figures depict a quadrilateral shape, this is meant to be exemplary only. The most common shapes for the cutting insert are quadrilateral as shown as well as pentagonal, triangular, square, circular, and chevron patterns. Other shapes are also suitable.

Referring now to FIG. 1, in use the cutting insert 10 of the present invention is typically clamped in the tool holder 9 and mounted in a lathe or other machine tool used in turning metals. Superabrasive cutting inserts similar to those of the present invention are widely used for machining high strength steels and other especially hard and difficult to machine materials. The superabrasive cutting inserts with integral chip breakers of the present invention will increase the efficiency and safety of such machining operations and are expected to supplant prior art non-chip breaker equipped inserts.

As can be seen, a new and improved superabrasive cutting insert has been provided. While only the exemplary embodiments have been described in detail, as will be apparent to those skilled in the art, modifications and improvements may be made to the device disclosed herein without departing from the scope of the invention. Accordingly, it is not intended that the invention be limited except as by the appended claims.

What is claimed is:

1. A superabrasive cutting insert comprising, a generally flat, composite wafer of predetermined shape and thickness, the wafer having a center layer of ultra-hard material, the center layer being integrally joined to top and bottom support layers, wherein an edge of the center layer forms a cutting edge along one side of the wafer, the wafer including at least one profiled chip breaker formed inwardly of the cutting edge by selectively removing a portion of at least one of the top or bottom support layers inwardly from the cutting edge.

2. The cutting insert of claim 1, wherein center layer forms a plurality of cutting edges about the periphery of the wafer

3. The cutting insert of claim 1, wherein center layer is selected from the group consisting of polycrystalline diamond, polycrystalline cubic boron nitride, and mixtures thereof.

4. The cutting insert of claim 1, wherein the support layers comprise cemented carbide.

5. The cutting insert of claim 4, wherein the material of the support layers is selected from the group consisting of cemented tungsten carbide, tungsten, tantalum, niobium, palladium, iron, nickel, cobalt, alloys of such metals, and intermetallic compounds containing such metals.

6. The cutting insert of claim 1, wherein the top layer is tungsten carbide and the bottom layer is tungsten.

7. The cutting insert of claim 1, wherein the chip breaker profile is that of a ramp of predetermined angle.

8. The cutting insert of claim 7, wherein the ramp angle is within the range of about 5 to about 60 degrees.

9. The cutting insert of claim 1, wherein the chip breaker profile convex.

10. The cutting insert of claim 8, wherein the convex profile has a radius of curvature of about 0.010 to about 0.100 inches.

11. The cutting insert of claim 1, wherein the chip breaker profile is concave.

12. The cutting insert of claim 11, wherein the concave profile has a radius of curvature of about 0.010 to about 0.100 inches.

13. The cutting insert of claim 1, wherein the chip breaker is set back from the cutting edge.

14. The cutting insert of claim 1, wherein the chip breaker is set back from the cutting edge within a range of about 0.005 to about 0.125 inches.

15. A superabrasive cutting insert comprising, a generally flat, composite wafer of predetermined shape and thickness, the wafer having a layer of ultra-hard material, the ultrahard layer being integrally joined to a single support layer, wherein an edge of the ultra-hard layer forms a cutting edge along one side of the wafer, the wafer including at least one profiled chip breaker formed inwardly of the cutting edge by selectively removing a portion of the single support layer inwardly from the cutting edge.

16. A superabrasive cutting insert comprising:
a first support layer;
a second support layer;
an ultra hard material layer having a first surface opposite a second surface surrounded by a periphery and having a cutting edge defined on at least a portion of the periphery;
a first support layer bonded to the first surface; and
a second support layer bonded to the second surface, wherein the second support layer has an end that does not extend to the cutting edge thereby exposing a portion of the second surface, wherein the second layer end forms a chip breaker.

17. A superabrasive cutting insert as recited in claim 16 wherein the second layer end is convex.

18. A superabrasive cutting insert as recited in claim 16 wherein the second layer end is concave.

19. A superabrasive cutting insert as recited in claim 16 wherein the second layer end forms a ramp extending toward the cutting edge in a direction toward the second surface.

20. A superabrasive cutting insert as recited in claim 16 wherein the ramp is angled relative to the second surface of about 5 to about 60 degrees.
